(19) United States
(12) Patent Application Publication
(10) Pub. No.: US 2020/0164683 A1
(43) Pub. Date: May 28, 2020

(54) VEHICLE WHEEL

(71) Applicant: HONDA MOTOR CO., LTD., Tokyo (JP)

(72) Inventors: Toshinobu SAITO, Wako-shi (JP); Yusuke OSAWA, Wako-shi (JP); Youichi KAMIYAMA, Wako-shi (JP)

(21) Appl. No.: 16/685,202

(22) Filed: Nov. 15, 2019

(30) Foreign Application Priority Data
Nov. 22, 2018 (JP) 2018-218815

(51) Int. Cl. B60B 21/12; G10K 11/172

(52) U.S. Cl. CPC B60B 21/12; B60B 2900/133; G10K 11/172

(57) ABSTRACT

Provided is a vehicle wheel including a sub air chamber member as a Helmholtz resonator which is mounted to a well portion. The sub air chamber member includes engaged portions, to be engaged with engaging portions (hooking portions) formed in the well portion, along both end edges in a wheel width direction, and each of the engaged portions of the sub air chamber member includes a folded claw to engage with the engaging portion (hooking portion) of the well portion.

### CROSS-REFERENCE TO RELATED APPLICATION

The present application claims the benefit of priority to Japanese Patent Application No. 2018-218815 filed on Nov. 22, 2018, the disclosures of all of which are hereby incorporated by reference in their entireties.

### TECHNICAL FIELD

### Field of the Invention

The invention relates to vehicle wheel.

### BACKGROUND OF THE INVENTION

There has been known a vehicle wheel including sub air chambers, defined by lid members covering a well portion of the wheel, as a wheel including Helmholtz resonators (sub air chamber members) to attenuate air column resonance sound in a tire air chamber (see Japanese Patent Application Publication No. JP2005-219739, for example). This Helmholtz resonator defines the sub air chamber between an outer peripheral surface of the well portion and the lid member so that a structure thereof is simplified.

### SUMMARY OF THE INVENTION

However, in the related-art wheel (see Japanese Patent Application Publication No. JP2005-2197391, for example), the sub air chamber member is joined to the well portion by welding or the like in order to prevent the Helmholtz resonators from falling off the well portion due to a centrifugal force applied during wheel rotation. This causes a problem that manufacturing processes for the wheel are complicated.

An aspect of the present invention is to provide a vehicle wheel in which a Helmholtz resonator (sub air chamber member) is easily and rigidly mounted to a well portion of the wheel.

A vehicle wheel of the present invention to solve the problem includes a sub air chamber member, as a Helmholtz resonator, mounted to a well portion of the wheel. The sub air chamber member includes engaged portions, to be engaged with engaging portions formed in the well portion, along both end edges in a wheel width direction, wherein each of the engaged portions of the sub air chamber member includes a folded claw to engage with the engaging portion of the well portion.

According to the vehicle wheel of the present invention, the Helmholtz resonator (sub air chamber member) is easily and rigidly mounted to the well portion.

### BRIEF DESCRIPTION OF THE DRAWINGS

FIG. 1 is an entire perspective view of a vehicle wheel according to an embodiment of the present invention;

FIG. 2 is a partial cross-sectional view taken along a line II-II of FIG. 1;

FIG. 3 is a partial cross-sectional view taken along a line III-III of FIG. 2;

FIG. 4 is a partial cross-sectional view taken along a line IV-IV of FIG. 3;

FIG. 5 is a cross-sectional view of a vehicle wheel according to a first modification, corresponding to the cross-sectional view taken along the line II-II of FIG. 1;

FIG. 6 is a cross-sectional view of a vehicle wheel according to a second modification, corresponding to the cross-sectional view taken along the line II-II of FIG. 1; and

FIG. 7 is a cross-sectional view of a vehicle wheel according to a third modification, corresponding to the cross-sectional view taken along the line II-II of FIG. 1.

### DETAILED DESCRIPTION OF THE PREFERRED EMBODIMENTS

Next, a description is given in detail of a vehicle wheel according to an embodiment of the present invention with reference to the drawings as appropriate. In the referenced drawings, “X” indicates a wheel circumferential direction, “Y” indicates a wheel width direction, and “Z” indicates a wheel radial direction, respectively. Further, in the wheel width direction Y, a portion of an outer peripheral surface of a well portion of the wheel closer to the center of the surface may be referred to as an “inner side in the wheel width direction Y”, and a portion of the surface closer to the rim flange may be referred to as an “outer side in the wheel width direction Y.”

In the following description, an entire structure of the vehicle wheel is described at first, and then a sub air chamber member as a Helmholtz resonator is described.

### Entire Structure of Vehicle Wheel

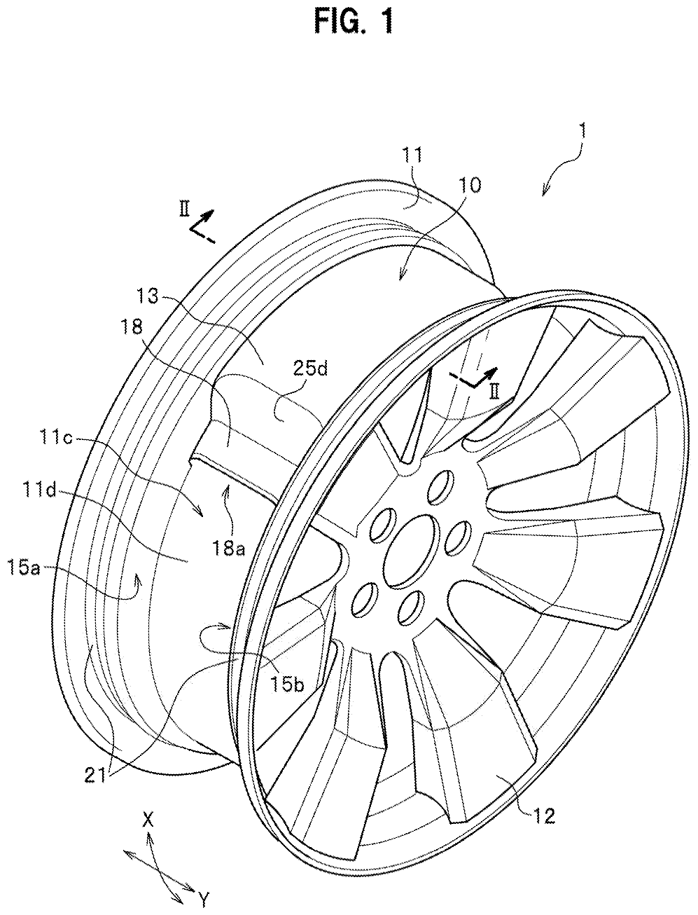

FIG. 1 is an entire perspective view of a vehicle wheel 1 according to an embodiment of the present invention.

As illustrated in FIG. 1, the vehicle wheel 1 according to the embodiment of the present invention includes a metal rim 11 made of an aluminum alloy, a magnesium alloy, or the like, for example, and a sub air chamber member 10 (Helmholtz resonator), which is a lid member made of a synthetic resin or metal, mounted to the rim 11.

In FIG. 1, reference numeral 12 denotes a disk with which the rim 11 is coupled to a hub (not shown).

The rim 11 includes a well portion 11c which is recessed inward (toward the rotation center) in the wheel radial direction between bead seats 21 formed at both end portions in the wheel width direction Y, respectively. An outer peripheral surface 11d of the well portion 11c defined by the bottom surface of the recess has substantially the same diameter across the wheel width direction Y about a wheel axis.

The rim 11 of the present embodiment described above includes a pair of vertical walls 15a and 15b facing each other in the wheel width direction Y. These vertical walls 15a and 15b rise outward in the wheel radial direction from the outer peripheral surface 11d at predetermined distances in the wheel width direction Y. The respective vertical walls 15a and 15b of the present embodiment are assumed to be formed on portions of the rim rising from the outer peripheral surface 11d of the well portion 11c to the rim flange side.

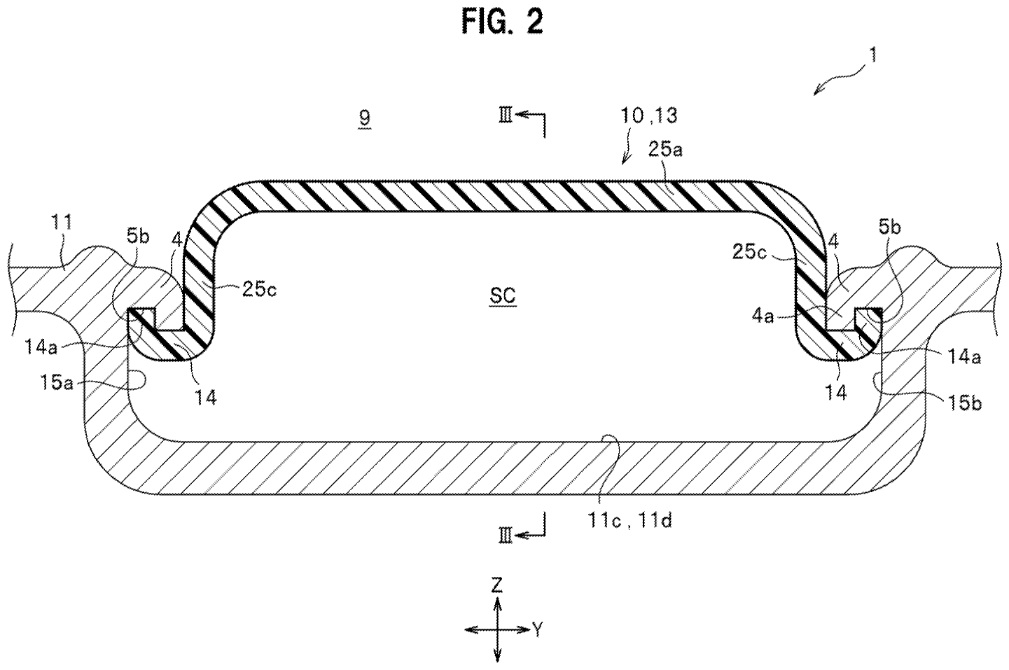

FIG. 2 is a cross-sectional view taken along a line II-II of FIG. 1.

As illustrated in FIG. 2, hooking portions 4 are formed at outer end portions (upper end portions) in the wheel radial direction Z of the vertical walls 15a and 15b.

The hooking portions 4 are referred to as “engaging portions” in the appended claims.

As viewed in a cross section, shown in FIG. 2, intersecting the wheel circumferential direction X (see FIG. 1), the hooking portions 4 are formed of distal end portions 4a, which protrude inward in the wheel width direction Y from the upper end portions of the vertical walls 15a and 15b, bent inward in the wheel radial direction Z. Groove portions 5b, which are open downward, are defined between the distal end portions 4a of the bent hooking portions 4 and the vertical walls 15a and 15b. The groove portions 5b extend in the wheel circumferential direction X (see FIG. 1).

As described below, folded claws 14a of the sub air chamber member 10 are fitted into the groove portions 5b.

### Sub Air Chamber Member

Next, the sub air chamber member 10 is described.

As illustrated in FIG. 1, the sub air chamber member 10 is a member elongated in the wheel circumferential direction X and is formed of a three-dimensional structure of a bent plate.

The sub air chamber member 10 includes a main body portion 13 and a communication hole forming portion 18.

The sub air chamber member 10 is curved longitudinally along the wheel circumferential direction X.

The sub air chamber member 10, which is a lid member, partially covers the outer peripheral surface 11d of the well portion 11c in the wheel circumferential direction X.

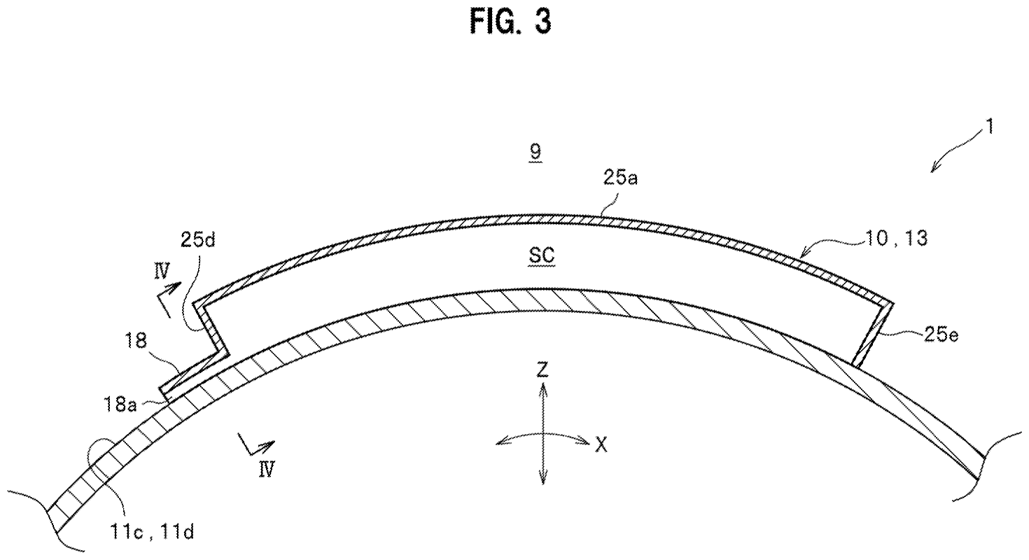

Accordingly, a sub air chamber SC (see FIG. 2) is defined between the main body portion 13 and the outer peripheral surface 11 as described below. Further, a communication hole 18a (see FIG. 3) is defined between the communication hole forming portion 18 and the outer peripheral surface 11d as described below.

As illustrated in FIG. 2, the main body portion 13 includes an upper plate 25a, a pair of side plates 25c, and a pair of edge portions 14. As viewed in a cross section, shown in FIG. 2, intersecting the wheel circumferential direction X (see FIG. 1) , the upper plate 25a, together with the side plates 25c and the edge portions 14, forms a substantially hat-shape which is open toward the outer circumferential surface 11d.

The upper plate 25a is formed of a plate which faces the outer peripheral surface 11d of the well portion 11c at a predetermined distance.

The side plates 25c are formed to respectively extend from both outer end portions in the wheel width direction Y of the upper plate 25a toward the outer peripheral surface 11d of the well portion 11c.

The upper plate 25a and the pair of side plates 25c form a convex upward portion in a substantially hat-shape.

The edge portions 14 are formed of the plate which is bent to extend outward in the wheel width direction Y from inner end portions (lower end portions) in the wheel radial direction Z of the side plates 25c.

The edge portions 14 form flange portions having a substantially hat-shape.

The folded claws 14a are formed at the outer end portions in the wheel width direction Y of the edge portions 14.

The folded claw 14a is referred to as an “engaged portion” in the appended claims.

The folded claws 14a are formed to bent outward in the wheel radial direction Z from the outer end portions in the wheel width direction Y of the edge portions 14.

As viewed in a cross section, shown in FIG. 2, intersecting the wheel circumferential direction X (see FIG. 1), the edge portions 14 including the folded claws 14a as described above, together with the lower end portions of the side plates 25c, form a substantially U-shape which is open upward.

Further, as described above, the folded claws 14a are fitted into the groove portions 5b of the rim 11. Thus, the distal end portions 4a of the hooking portions 4 of the rim 11 are engaged between the folded claws 14a and the lower end portions of the side plates 25c.

That is, the hooking portions 4 and the folded claws 14a are engaged with each other to have a labyrinth structure for coupling.

Further, as illustrated in FIG. 1, the main body portion 13 includes an end plate 25d which is arranged at one end portion in the wheel circumferential direction X.

FIG. 3 is a partial cross-sectional view taken along a line III-III of FIG. 2.

As illustrated in FIG. 3, the end plate 25d closes the one end portion in the wheel circumferential direction X of the main body portion 13 except the communication hole 18a defined by the communication hole forming portion 18. Further, an end plate 25e is arranged at the other end portion in the wheel circumferential direction X of the main body portion 13.

The end plate 25e closes the other end portion in the wheel circumferential direction X of the main body portion 13.

The sub air chamber SC is surroundedly defined by the upper plate 25a, the end plates 25d and 25e, the side plates 25c (see FIG. 2), and the outer peripheral surface 11d of the well portion 11c.

The sub air chamber SC is communicated with the tire air chamber 9 through the communication hole 18a to be described below.

As illustrated in FIG. 3, the communication hole 18a is defined by a gap between the communication hole forming portion 18 of the sub air chamber member 10 and the outer peripheral surface 11d of the well portion 1c.

The communication hole forming portion 18 is connected to an inner end portion (lower end portion) in the wheel radial direction Z of the end plate 25d, and is formed of a plate extending in the wheel circumferential direction X at a predetermined distance from the outer peripheral surface 11d.

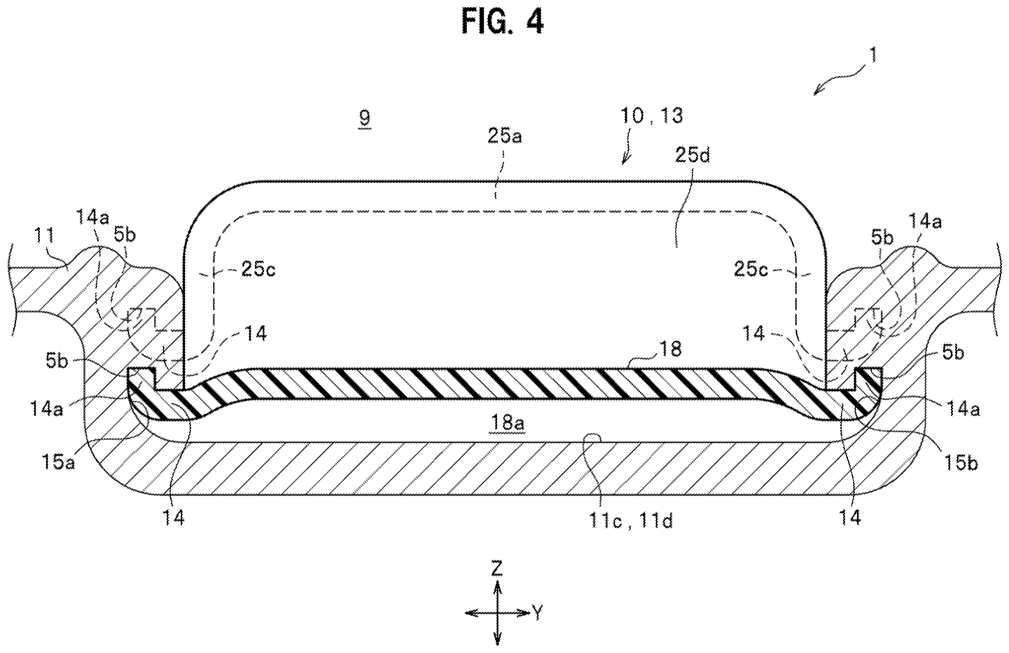

FIG. 4 is a partial cross-sectional view taken along a line IV-IV of FIG. 3.

In FIG. 4, the upper plate 25a, the side plates 25c, the edge portions 14, and the folded claws 14a of the main body portion 13 are indicated by a hidden line (dotted line). Further, the groove portions 5b of the rim 11, in which the folded claws 14a of the main body portion 13 are fitted, are also indicated by the hidden line (dotted line).

As illustrated in FIG. 4, the communication hole forming portion 18 is connected to the lower end portion of the side endplate 25d as described above, and both end portions thereof extending in the wheel width direction Y are engaged with the rim 11.

In particular, the communication hole forming portion 18 is engaged with the rim 11 through the edge portions 14 arranged at the both end portions in the wheel width direction Y of the communication hole forming portion 18 as indicated by the hidden line (dotted line).

The folded claws 14a (engaged portions) are formed at the outer end portions in the wheel width direction Y of the edge portions 14.

The folded claws 14a are formed to be bent outward in the wheel radial direction Z from the outer end portions in the wheel width direction Y of the edge portions 14.

Further, the folded claws 14 are fitted into the groove portions 5b of the rim 11.

The groove portions 5b, into which the folded claws 14a of the communication hole forming portion 18 are fitted, extend in the wheel circumferential direction X at a more inner side in the wheel radial direction Z than the groove portions 5b (indicated by the hidden line (dotted line)), into which the folded claws 14a (indicated by the hidden line (dotted line)) of the main body portion 13 are fitted.

The folded claws 14a of the communication hole forming potion 18 form a labyrinth structure together with the groove portions 5b, into which the folded claws 14a are fitted, as with the folded claws 14a (indicated by the hidden line (dotted line)) of the main body portion 13.

A length L and a cross-sectional area S of the communication hole 18a are set to satisfy an equation for determining a resonance frequency of the Helmholtz resonator expressed by the following equation 1.

fₒ=C/2π×√(S/V(L+α×√S) (Equation 1)

where fₒ (Hz) : resonance frequency of the tire air chamber 9,
C (m/s) : sound velocity inside the sub air chamber SC (=sound velocity inside the tire air chamber 9),
V (ms): volume of the sub air chamber SC,
L (m): length of the communication hole 18a,
S (m²): cross-sectional area of the communication hole 18a, and
α: correction coefficient.

The vehicle wheel 1 of the present embodiment is assumed to have four sub air chamber members 10 arranged in the wheel circumferential direction X at the same intervals. The sub air chamber members 10 of the vehicle wheel 1 as described above are arranged such that the openings, which face the tire air chamber 9, of the communication holes 18a are positioned at intervals of 90 degrees about the wheel rotation axis.

According to the sub air chamber members 10 arranged as described above, so-called “unevenness in sound attenuation” of air column resonance sound, which is generated in the tire air chamber 9 during wheel rotation, can be more reliably prevented.

Note that the number of sub air chamber members 10 is not limited thereto. Therefore, when the number of sub air chamber members 10 is two, the openings of the respective communication holes 18a can be arranged at positions 90 degrees apart from each other about the wheel rotation axis. Further, when the number of sub air chamber members 10 is equal to three, or equal to or more than five, the openings of the respective communication holes 18a can be arranged at the same intervals in the wheel circumferential direction X.

In a mounting method of the sub air chamber member 10 as described above to the rim 11, the sub air chamber member 10 is firstly inclined such that one of the pair of edge portions 14 which correspond to the flange portions having a substantially hat-shape is positioned at a lower side of the rim 11. Then, the folded claw 14a of the one edge portion 14 is fitted into the groove portion 5b. Thereafter, the other edge portion 14 is pressed toward the well portion 11c by a given pusher so that the other edge portion 14 in contact with the hooking portion 4 is elastically deformed, and the folded claw 14a is positioned at a lower side of the hooking portion 4. As a result, the folded claw 14a of the other edge portion 14 is fitted into the groove portion 5b.

The contact portion, between the edge portions 14 and the end plate 25e of the sub air chamber member 10, and the rim 11, is applied with a sealing material, and the mounting of the sub air chamber member 10 to the rim 11 is completed. In the mounting method, the sealing material is assumed to be applied after the sub air chamber member 10 is mounted to the rim 11. However, the sub air chamber member 10 may be mounted to the rim 11 after the sealing material is preliminary applied to predetermined portions of the sub air chamber member 10 or the rim 11.

The sealing material is not particularly limited, but a curable silicone resin (silicone rubber) or other synthetic rubber such as ethylene propylene rubber may be used for example.

Next, advantageous effects obtained by the vehicle wheel 1 of the present embodiment is described. In the vehicle wheel 1 of the present embodiment, the folded claws 14a (engaged portions) of the sub air chamber member 10 engage with the hooking portions 4 (engaging portions) of the well portion 11c.

Thus, the vehicle wheel 1 differs from a conventional wheel (see Japanese Patent Application Publication No. JP2005-219739, for example) on the point that the sub air chamber member 10 (Helmholtz resonator) can be easily and rigidly mounted to the well portion 11c without the need for welding or the like.

Further, in the vehicle wheel 1 according to the present embodiment, the folded claws (engaged portions) 14a engage with the hooking portions (engaging portions) 4 of the well portion 11c in a labyrinth structure for coupling.

According to the sub air chamber member 10 as described above, a large contact area can be secured between the rim 11 and the edge portions 14. With this structure, performance of the sub air chamber member 10 being held to the rim 11 can be further improved, and airtightness of the sub air chamber SC, when the sealing material is applied, can be further improved.

The present embodiment has been described as above, but the present invention is not limited thereto and can be executed in various forms.

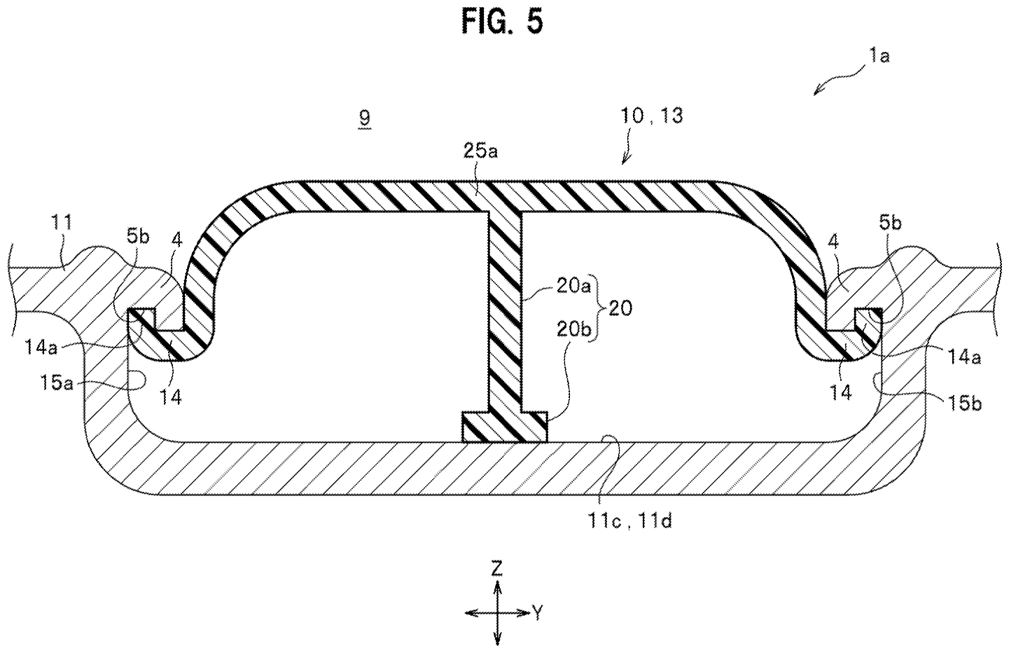

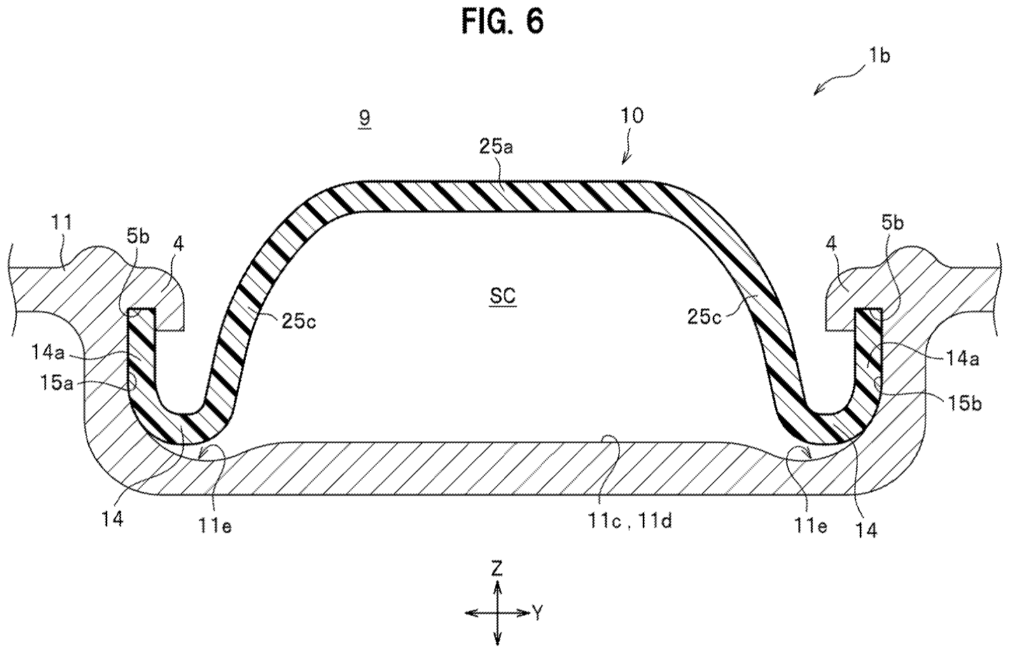

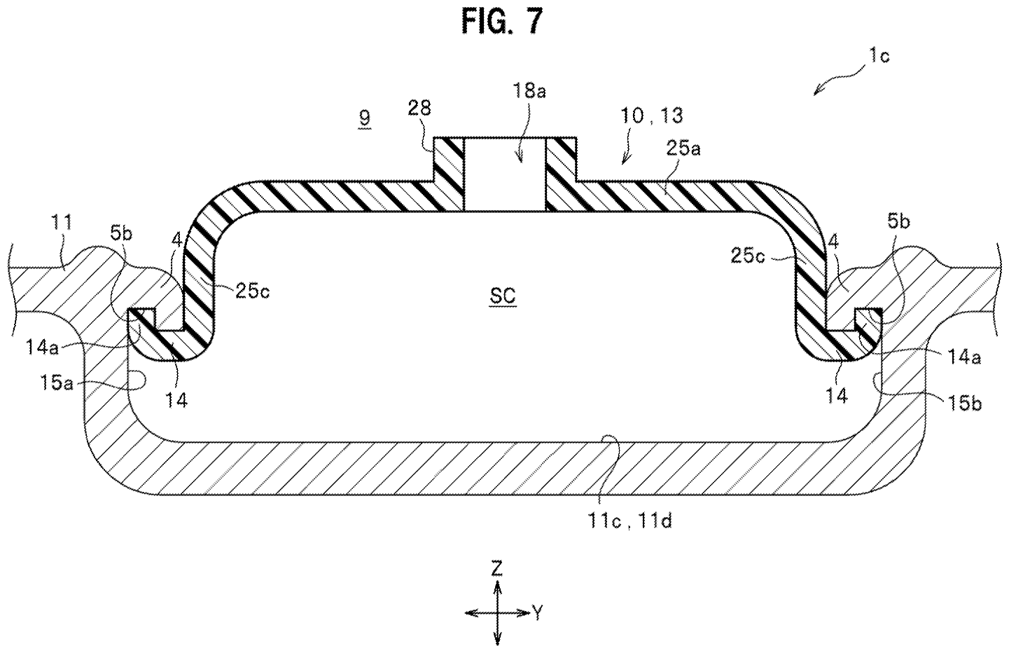

FIG. 5 to be referred to next is a cross-sectional view of a vehicle wheel 1a according to a first modification, FIG. 6 is a cross-sectional view of a vehicle wheel 1b according to a second modification, and FIG. 7 is a cross-sectional view of a vehicle wheel 1c according to a third modification. These drawings, FIG. 5 to FIG. 7, correspond to the cross-section taken along the line II-II in FIG. 1 for the embodiment. In the first to third modifications, the same components as those in the embodiment described above are denoted by the same reference numerals, and the detailed descriptions thereof are omitted.

The vehicle wheel 1a according to the first modification illustrated in FIG. 5 differs from the vehicle wheel 1 (see FIG. 2) according to the embodiment described above on the point that the main body portion 13 of the sub air chamber member 10 includes an inner wall portion 20. The inner wall portion 20 includes a wall main body 20a which is joined to the center portion in the wheel width direction Y inside the upper plate 25a of the main body portion 13 to extend downward, and a contact portion 20b which is joined to, so as to form a T-shape, the wall main body 20a at a lower portion of the wall main body 20a, to be in contact with the outer peripheral surface 11d of the well portion 11c.

The inner wall portion 20 described above is formed to extend in the wheel circumferential direction X (see FIG. 1) inside the main body portion 13. However, the inner wall portion 20 is not formed in the entire area in the longitudinal direction (wheel circumferential direction X) of the main body portion 13. Therefore, the inner wall portion 20 does not completely partition the inside of the main body portion 13 in the wheel width direction Y, to have a single sub air chamber SC formed in the main body portion 13.

According to the vehicle wheel 1a of the first modification described above, a reaction force is generated from the outer peripheral surface 11d of the well portion 11c at the lower portion of the inner wall portion 20, together with an elastic force exerted by the sub air chamber member 10 when the sub air chamber member 10 is mounted to the rim 11 according to the mounting method described above. Thus, in the vehicle wheel 1a, a fitting force between the hooking portions 4 of the rim 11 and the folded claws 14a of the sub air chamber member 10 is improved due to the reaction force.

According to the vehicle wheel 1a described above, the sub air chamber member 10 can be more rigidly mounted to the rim 11.

Further, the vehicle wheel 1a is assumed to have one inner wall portion 20, but the number and the position of the inner wall portions 20 and the orientation of the wall surface of the inner wall portion 20 are not limited thereto.

Therefore, a plurality of inner wall portions 20 may be arranged in the wheel width direction Y or the wheel circumferential direction X. Still further, the wall surface of the inner wall portion 20 may be arranged to be oriented in the wheel circumferential direction X.

Next, a description is given of the vehicle wheel 1b according to the second modification.

As illustrated in FIG. 6, the vehicle wheel 1b according to the second modification differs from the vehicle wheel 1 (see FIG. 2) of the embodiment described above on the point that side plates 25c extend from the upper plate 25a to the vicinities of the outer periphery surface 11d of the well portion 11c. Further, the folded claws 14a of the edge portions 14, which forms a U-shape with the side plates 25c, extend upward from a position closer to the outer peripheral surface 11d while being in contact with the vertical walls 15a and 15b and the distal ends thereof are fitted into the groove portions 5b.

In FIG. 6, reference numerals 11e denote recessed portions for securing a downward overstroke of the edge portions 14 when the distal ends of the folded claws 14a are fitted into the groove portions 5b.

According to the vehicle wheel 1b described above, a large contact area can be secured between the rim 11 and the edge portions 14. With this structure, the performance of the sub air chamber member 10 being held to the rim 11 can be further improved, and the airtightness of the sub air chamber SC, when the sealing material is applied, can be further improved.

Next, a description is given of the vehicle wheel 1c according to the third modification.

As illustrated in FIG. 7, the vehicle wheel 1c according to the third modification differs from the vehicle wheel 1 (see FIG. 2) of the embodiment described above on the point that the communication hole 18a is formed in a pipe body 28 provided in the upper plate 25a.

Further, in the sub air chamber member 10 of the vehicle wheel 1c, though not illustrated, both end portions in the wheel circumferential direction X are closed by a pair of end walls. The pair of end walls can have a structure similar to the end plate 25d (see FIG. 3) in the embodiment described above.

Further, the pipe body 28 of the vehicle wheel 1c is formed in the upper plate 25a, but may be formed in either of the end walls which close both of the end portions in the wheel circumferential direction X, in place of the upper plate 25a.

Still further, the sub air chamber member 10 of the vehicle wheels 1, 1a, 1b, and 1c is assumed to be composed of a lid member which defines the sub air chamber SC with the outer peripheral surface 11d of the well portion 11c, but the vehicle wheel of the present invention may have a structure, in which the sub air chamber member 10 in a box-shape having the sub air chamber SC defined in the hollow portion thereof is engaged with the rim 11 through the edge portions 14.

What is claimed is:

1. A vehicle wheel, comprising:
a sub air chamber member as a Helmholtz resonator which is mounted to a well portion of the vehicle wheel,
wherein the sub air chamber member includes engaged portions, to be engaged with engaging portions formed in the well portion, along both end edges in a wheel width direction, and
wherein each of the engaged portions of the sub air chamber member includes a folded claw to engage with each of the engaging portions of the well portion.

2. The vehicle wheel as claimed in claim 1, wherein the folded claw formed as the engaged portion engages with the engaging portion of the well portion to have a labyrinth structure for coupling.
